(19) United States
(12) Patent Application Publication
(10) Pub. No.: US 2009/0311392 A1
(43) Pub. Date: Dec. 17, 2009

(54) Novel approach to the controlled decontamination and or detoxification of nuts, grains, fruits and vegetables

(76) Inventor: PAUL BERNARD NEWMAN, Fallbrook, CA (US)

Correspondence Address: Dr Paul B Newman, 4221 Fallsbrae Road, Fallbrook, CA, 92028, US

(21) Appl. No.: 12/211,571

(22) Filed: Sep. 16, 2008

Related U.S. Application Data
(60) Provisional application No. 60/973,903, filed on Sep. 20, 2007.

(51) Int. Cl. A23L 3/28; A23B 7/015; A23L 3/34; A23L 3/3418; A23L 3/3454

(52) U.S. Cl. 426/248

(57) ABSTRACT

A method and apparatus are described with which a wide range of foodstuffs can be effectively, simultaneously or consecutively, decontaminated and/or detoxified using a combined treatment of water, a heating source and defined wavelength Ultraviolet light within or without the use of a modified atmosphere. The modular system allows easy, quick and low cost adaptation to suit the decontamination and/or detoxification of almost any solid foodstuff.

Unlike existing technologies, the effective control of heat on or over the product prevents denaturation, thus allowing organic and natural product to retain its viability and status.

### FIELD OF INVENTION

This invention relates to a continuous method and apparatus for simultaneously or separately reducing or eliminating either or both microbial contamination and mycotoxin contamination, especially aflatoxins and fumonisins, in solid foodstuffs particularly nuts, grains, fruits and vegetables and with particular reference to nuts, such as but not limited to, almonds, pecans, peanuts, walnuts, pistachios and Brazil nuts.

It also relates to making use of quantifiable data on said contaminations and dynamically modifying said method to maximize throughput, minimize cost and optimize performance.

### BACKGROUND TO THE INVENTION

While foodstuffs in general suffer from microbial contamination, there are additional problems with foodstuffs such as nuts, grains, fruits and vegetables. They are frequently attacked by insects as well as other microbial pathogens and damage by the former often creates avenues of entry for the latter. As a consequence, they often suffer from more than one form of contamination and need both decontamination treatment to remove any microbial contaminants, especially pathogenic food spoilage organisms such as Salmonella, Listeria, Camphylobacter or E.coli as well as a detoxification treatment to remove chemical contaminants particularly highly toxic aflatoxins developed following fungal infections, the visible signs of which have often disappeared long before the harvested product is transferred to storage or to processing. In good growing seasons, such foodstuffs often suffer from both microbial and aflatoxin contamination as the conditions for growth of the foodstuff parallel those needed for their pathogens.

There are many examples of specific treatments being developed to treat one or other of these contaminations and the reader is directed to British Patent GB 2388764 for a detailed summary of published and patented detoxification methods for foodstuffs. Similarly, U.S. Pat. No. 5,597,597 details a range of microbial decontamination methods.

Effective decontamination requires direct contact between the decontamination medium and the organism. However the poorer the contact the more likely physical and chemical changes will occur as most of the physical treatments involve heat either directly or as a byproduct. For example, as a consequence of recent regulatory changes in product specification such as the mandatory pasteurization of US Almonds, there has a been a surge in the development of steam and water heat based technologies as typified by commercially available technologies such as Ventilex, H2O Express, JSP and variants such as vacuum steam pasteurization or sterilisation.

As a result of recent major product contaminations, decontamination requirements have become more rigourous. The California Almond Board (CAB) now requires a minimum 4-log and preferably a 5-log kill. This is difficult to achieve under mass flow manufacturing conditions. Almonds have additional problems, they are not smooth they are ridged and unlike many harvested foodstuffs, they often spend months in store before processing, often outside. Storage and processing is dirty, the nuts frequently become extremely contaminated with dirt, dust and physical detritus, for example peanuts by their very nature are in constant contact with the soil.

However it is equally and economically important not to cause product quality attributes to be downgraded so any treatment has to be selected to meet the required product criteria. The highest financial returns are most frequently obtained for natural, often organic, products that are in an uncooked, raw native state and therefore not exposed to any or minimal ‘kill steps’ during harvest, storage or processing to reduce or eliminate pathogens and/or reduce or eliminate aflatoxins. As a consequence, it is often essential that such products are processed in a dry or low moisture environment and not subjected to wet processes or chemical techniques that introduce or utilise compounds not considered natural, i.e. not normally associated with the product in its normal environment. Nor can they be subjected to thermal energies that would change their composition, state or appearance.

Current commercial decontamination technologies are based either on batched based chemical interactions such as Propylene Oxide (PPO) or Hemin (EP1533083) or inactivating enzymes (WO2005021740) or various forms of batch or continuous flow steam pasteurization such as those detailed in US Patent Applications 20050112255, 20050147594 and 20060029704. All of the chemical treatments are costly both in terms of time and money. They also make it impossible to classify the finished products as either organic or natural.

The effects of steam-based treatments have been well documented for many decades, (c.f. West German Patent 1914095) Primarily they cause the inactivation of organisms through heat denaturation, principally the destruction of essential enzymes by exposing the organisms to elevated temperatures. Unfortunately, if the temperatures denature the organism, they similarly denature the product they are pasteurizing. As with the chemical treatments, they have a quality downside as they effectively kill the nut or grain and, it is alleged, have a deleterious effect on nutritional composition, although this may not be easily detectable through typical sensory evaluation characteristics such as appearance, smell and taste. This also has a potential major financial downside as the products cannot be sold as organic nor native. With the change in regulations, there is also intense debate as to whether they need to be labeled as pasteurized. Milk which has been exposed to temperatures of 90° C. for 10 seconds is labeled pasteurized. All of the current approved steam pasteurization treatments actually or potentially expose nuts and grains to higher temperatures than this for much longer time periods. They can also cause a change in total product moisture content which requires that the product be subjected to still further treatment or processing to remove this additional added water and return the product to its original moisture content or risk requiring labeling stating ‘added water’. Some technologies attempt to limit the time and temperature exposure by increasing the temperature of the steam so that the same decontamination effect can be achieved in a shorter time. While this can subject less of the volume of each nut or grain to degradation, that volume of nut that is exposed is likely to suffer a greater degradation because of the higher temperatures encountered at the interface between the decontamination treatment and the foodstuff.

Steam based treatments are less expensive in terms of time and cost than chemical treatments. However the capital cost of the equipment needed to undertake them is often extremely expensive. They are also extremely high consumers of energy. For example, one commercially available HTST (High Temperature Short Time) steam pasteurisation claims reduced cost and yet it specifies it needs a 3-phase power supply in excess of 165 Amps, equivalent to more than 760 KW. The poorer the control of the rate of heat transfer, the poorer the performance and efficiency and the more likely the product will suffer quality degradation.

There are other decontamination techniques based on physical techniques that are considered non-degrading such as Ozone (U.S. Pat. No. 6,294,211), Ozone with shortwave Ultraviolet and Ultrasound (U.S. Pat. No. 5,498,431) and shortwave Ultraviolet (U.S. Pat. No. 5,597,597). U.S. Pat. No. 6,294,211 contains an extensive reference of patents using Ozone either in isolation or in addition with other components that claim to achieve this decontamination effect on a wide range of foodstuffs.

Shortwave UV alone is clearly capable of achieving greater than a 4-log reduction in total organisms even on difficult products with irregular surfaces such as nuts and meat (see Table 1 this application and Table 3, U.S. Pat. No. 5,597,597). It also clearly capable of achieving sterilization conditions rather than pasteurization in a very short timescale, 10 seconds or less (Table 1 this application and Table 2, U.S. Pat. No. 5,597,597).

All of these foodstuffs are often subjected to minimal or nil processing prior to consumption except for simple washing. Most microbial sources of contamination, bacteria, fungi or yeasts exude polysaccharide material which has a dual function both to better adhere the organism to its substrate and to form a protective barrier around itself to resist chemical and/or physical treatment or removal as well as to better adhere dirt, soil and detritus to itself and its substrate surface. Consequently, conventional cold water washing has little effect in removing either contamination or the sources of contamination. Water containing additional decontaminating chemicals such as Chlorine, hypochlorite, bisulphate or Ozone or additionally a wetting agent (U.S. Pat. No. 5,082,679), have been shown to be more effective on foodstuffs than water alone, providing the foodstuff is clean and free from dust, dirt and detritus. In the presence of one or more of these materials, the decontamination capability rapidly decreases in inverse proportion to the physical contamination level.

British Patent 2388764 specifically states that when decontaminating product using shortwave UltraViolet ‘if washed, it must be air dried before further processing to ensure effective and reproducible treatment’. This patent also teaches that elevated humidities, together with elevated temperatures and catalysts of oxidation reactions, adversely affect product quality. Maintaining low humidities during the decontamination and detoxification processes, preferably 30% RH or lower, further reduces the rate of oxidative and hydrolytic reactions and better maintains original product quality. While microbial contamination of nuts, grains, fruits and vegetables is a particular problem especially as such products are often not subjected to any ‘kill step’ prior to consumption or where such kill step may be minimal such as washing with chlorinated water, the major benefits of such foods are their nutritional composition and their high financial value as organic, native, natural and an undenatured form. Such products also suffer from another potentially lethal source of contamination, namely aflatoxins. They are very heat stabile and can survive boiling in temperatures in excess of 100° C. for 3 hours. They are also extremely toxic to both man and his animals. They cause a range of irreversible carcinogenic disease in both humans and animals at concentrations as low as 20-30 ppb.

Unlike microbial contamination, aflatoxin contamination is often invisible and frequently very localized so that adjacent seeds or fruits may have very different levels of aflatoxin contamination. As a consequence, the ability to successful estimate overall toxin levels and/or isolate contaminated from non-contaminated product in mass flow processing operations is extremely difficult as is optimizing treatment conditions.

Steiner et al, (1988) found that removing all fluorescing figs from a 56 Kg batch reduced the original aflatoxin contamination level from 22.6 to 0.3 ppb. However Waked, (1984) found that in cotton seed 92% of fluorescing seeds contained aflatoxin while 8% of non-fluorescing seeds also contained aflatoxin. Similarly, Shotwell et al, (1975) found that after removing all fluorescing kernels and particles from batches of sweetcorn, cracking the corn and then re-inspecting with longwave UV revealed a further 19% of the crop had levels of aflatoxin greater than 3 ppb.

From financial, optimized processing operations and overall product quality standpoints, there is great benefit in being able to separate aflatoxin-contaminated product from non-contaminated product at the outset. There is little to be gained from subjecting effectively clean product to any extensive decontamination and detoxification program, it is an unnecessary expense for crops that are already subject to competitive pricing and it will slow down the total volume throughput, adding unnecessary further expense to processing costs.

Consequently we have developed an inspection and selection technique (the subject of a separate patent application) that, in real time, not only identifies potentially aflatoxin contaminated and/or microbially infected product, it also estimates aflatoxin concentration and diverts product into various risk bands for different subsequent treatment, and directly interacts with the technology described in this patent to both optimize the required treatment for each product selection and implement it in the manufacturing environment.

While current US regulations now mandate a product microbial decontamination treatment for almonds and selected other nut products, most other producer countries and most other nut, grain, fruit and vegetable crops are not so mandated. Therefore for the same financial, optimized processing operations and overall product quality standpoints, it is desirable to be able to maximize performance while minimising risk and cost. For example, it has already been shown that the UV-C decontamination technology detailed here has already been capable of generating a 2-log reduction in under 5 seconds and a 3-log in less than 10 seconds. There is little point or justification in subjecting product that has a minimal 3-log contamination to a 5-log treatment regime, especially as sterilizing a product introduces additional hazards associated with post-treatment recontamination.

Similarly, and more importantly from cost, time and quality perspectives, the vast majority of product is not contaminated or minimally contaminated with aflatoxin. While microbial decontamination systems suitable for commercial scale applications are available, detoxification treatments are much more costly and time-consuming than decontamination treatments as such toxins are much more resilient and cause a range of carcinogenic disease in both humans and animals including liver cancer, heart failure and renal damage at concentrations as low as 20-30 ug/kg (20-30 parts per billion).

The availability of suitable treatments is also much more limited. Aflatoxins are very heat stable and can withstand boiling (>100° C. for 3 hours) so the many variants of the steam pasteurization techniques used for microbial decontamination are ineffective. Similarly, the commonly used fumigants have not shown any detoxification capabilities (Brekke and Stringfellow, 1978)

While aflatoxins can be detoxified in alkaline solutions they are relatively stable in neutral and acid pH. However, even in neutral solutions, the presence of strong oxidisers such as bisulphites, hypochlorites or peroxides will lead to aflatoxin degradation. Unfortunately these reactions are time-sensitive, typically requiring 2 hours or greater, at elevated temperatures of 40° C. or greater and usually with additive concentrations of 1% or greater. Such treatments almost always result in significant product quality deterioration.

Most of these techniques are only applicable to aflatoxins in aqueous phases, or the foodstuff must have an elevated moisture content or a high water activity for significant detoxification to occur. None of the approved steam or fumigant treatments for microbial decontamination show any detoxification capabilities without major adaptation or modification.

The potential role of Ultraviolet wavelengths on aflatoxin degradation has been well studied both in isolation and in conjunction with oxidizing agents. Altug et al (1990) reported that 45% of B1 aflatoxin in aqueous phase was degraded within 30 minutes when exposed to a low energy source of UV-C but that neither the presence of bisulphite nor peroxide enhanced this degradation. Nkama and Muller (1988) exposed rice to different natural light intensities and moisture contents at 40° C. Both had an effect on the rate of degradation but there was no apparent synergism. Shantha et al (1978) showed that aflatoxin in ground nut oil can be more effectively destroyed by exposure to sunlight than longwave UV or visible light (from a tungsten lamp).

Maeba et al (1988) showed that B1 and G1 were easily degraded in the presence of 1 mg Ozone per litre within 5 minutes at 20° C. while B2 and G2 required 40× more Ozone and a minimum of 60 minutes exposure for the same level of detoxification. Yousef and Marth (1986) demonstrated that milk containing M1 aflatoxin when exposed to UV energy (254 nm) for 20 mins at 25° C. degraded 61% of that toxin while the addition of 0.05% hydrogen peroxide increased this degradation to 90%. However, the work of Price and Jorgensen (1985) and more recently JA Méndez-Albores et al., 2004 among others have shown that this degradation may be temporary and that in the presence of neutral or acidic conditions, recombination can occur.

While examples of successful detoxification in liquid or gaseous product have been described, those for solids and semi-solids are few (Goldblatt and Dolear, 1977). For example, Rasic et al (1990) reported significant detoxification of milk products in the presence of acids such as lactic and acetic while Magella and Hafez (1982) showed a similar effect with fermenting yoghurt. Manabe and Matsuura (1972) reported that although B1 and G1 aflatoxins were 50% decomposed during early stages of miso-fermentation, B2 and G2 were unaffected. Bencze and Kiermeier (1972) showed that exposing aflatoxin in solid phase to UV-C (254 nm) irradiation induced varying degrees of aflatoxin inactivation with G1 and B1 but no such inactivation occurred with the corresponding G2 and B2 aflatoxin; in all cases the effect was directly dependent on the amount of available oxygen. British Patent 1 117 573 showed that aflatoxin in peanut could be eliminated by exposure to hydrogen peroxide at a pH of 9.5 or greater. However, in the light of recombinant actions recently detailed and the lack of evidence to the contrary, the long term benefits of claimed detoxification under acidic conditions have to considered with great caution. U.S. Pat. No. 5,230,160 describes how aflatoxin can be denatured through microwave roasting but such a technique is obviously impractical for natural raw products. As an alternative, U.S. Pat. No. 5,229,007 removes aflatoxin from oils using activated carbon.

U.S. Pat. No. 5,082,679 uses a wetting agent and ammonia gas to detoxify contaminated foodstuffs. The temperature of the detoxification reaction reaches 60° C. and takes 30-90 minutes and it is claimed that the alkaline state prevents denatured aflatoxin from reforming once treatment ends. In a similar vein, U.S. Pat. No. 4,035,518 detoxifies peanut aflatoxin using an alkaline bath at 100° C. for about 30 minutes.

British Patent 2388764 teaches that medium pressure Mercury lamps emitting a broad spectrum UV radiation do detoxify aflatoxin. Because it also emits energy both in the visible range and has a very high energy output in the Infrared range, very significant cooling is necessary to prevent product deterioration and oxidation. It also teaches that to minimize potential oxidation two further steps are required: maintaining a dry atmosphere during decontamination and detoxification stages and using quartz glass sheets to physically separate the lamps from the foodstuff.

Finally, in addition to their stability, aflatoxins show a remarkable capability to reform, i.e. apparently denature and then reorganize themselves back to native, active forms. This phenomenon has been well documented and appears most prevalent when treated product is exposed to neutral or more especially acid conditions before storage or use. It has also been shown that significant aflatoxin reformation can occur in the human gut where strongly acidic conditions prevail.

Any successful commercial system must also demonstrate that any detoxification process is effective and non-reversible.

### SUMMARY OF THE INVENTION

We have been able to demonstrate a very effective decontamination method and apparatus that effectively combines one or more of 4 different decontamination technologies into a flexible single unique rapid synergistic treatment system that can render product either pasteurized or sterilized.

Similarly, we have been able to demonstrate that with minimal adaptation, the same decontamination method and apparatus can effectively detoxify aflatoxins in solid state foodstuffs without the need for liquid extraction agents, gaseous fumigants nor long duration treatments.

We have further demonstrated that any combination of methods can take place at commercial production and processing speeds without any detectable change in product quality attributes nor nutritional composition nor leaving product in a physical state suitable for aflatoxin reformation. Most importantly, the product remains in a native, viable state, thus allowing it to labeled as organic or natural.

As a further embodiment we have shown that when used in combination with a novel aflatoxin monitoring, measurement and sortation method, we can, dynamically and in real-time, modify all the system physical parameters so as to optimize both cost benefit and performance.

In another embodiment, we have been able to remove most of the energy requirement by eliminating the generation of large amounts of heat and correspondingly minimized the amount of energy needed to cool treated product.

Finally, because the method and apparatus ensures that no product is ever subjected to any measurable denaturation, nor exposed to any chemical that is not classified as natural, all product can still be classified as organic and/or natural and/or raw and therefore command the highest prices in the marketplace.

In a further embodiment we can ensure even treatment to all product by treating in a mono-layer, thus preventing excessive heat exposure, temperature rise or product denaturation.

Additionally, we are able to flexibly combine technologies and methodologies to suit product requirements and need ranging from maximal decontamination and maximal detoxification, maximal decontamination and minimal detoxification, minimal decontamination and maximum detoxification and variations between to produce positive, synergistic reactions.

For all the reasons previously stated, we have found that to ensure that any decontamination treatment is effective and reproducible, product needs to be free from debris and detritus. For product with non-smooth surfaces such as seeds and grains this is often difficult to achieve without a wet wash but unless this is very carefully controlled, it can lead to product deterioration and a loss of quality. Also, because of the high throughput volumes involved, often in excess of 10000 kg per hour, effective drying is correspondingly difficult and expensive. It is also well-known to all skilled in the art that decontamination of product surfaces with shortwave UV is much less effective in the presence of water due to minimal transmission in anything other than physically and chemically clear water.

As a further embodiment, we have been able to develop a method that provides an effective wash step but then in combination with a continuous dual energy system has a synergistic effect on the effectiveness and speed of microbial decontamination. The washing regime involves washing all sides of the product with 1 or more continuous but short duration sprays (preferably 2 or 3) of clean wash water (approximately 5-10 seconds each depending on product conditions), pH adjusted to be moderately acidic typically pH3.5-pH4.0. The water temperature can be in the range of 10° C. to 100° C. This may be with or without the addition of other natural chemicals such as surfactants and detergents; however it is principally due to the dissolving of the Carbon Dioxide in the water under the gas pressure of 1-2 atmospheres within the treatment chamber. This is followed by a separate but similar rinse regime. This has two product benefits, it removes >96% of the product detritus and cleans the product surfaces. It also has two major process benefits of saturating the air around the product which allows the CO2 modified atmosphere to hold more gas in a dissolved state and minimizes the presence of dust and dirt entering the treatment chamber thus eliminating the need to clean the lamps during normal processing, unlike British Patent 2388764 which states that ‘nuts and grains of these types produced considerable dust during the treatment period and required that conveying surfaces were cleaned and using the module D for eliminating recontamination as detailed . . . a wet clean was only needed approximately once every 2 hours. The accumulated dust also caused the lamps to gradually lose efficiency (as measured by total energy output) and all lamps were subjected to a moist clean every 8 hours’.

However, the most important benefit and an embodiment in this patent, is that it allows any residual microbial population, bacterial, yeast or fungal in origin, to become fully turgid and surrounded by a film of moisture so the system has the ability to have a delay period between product wetting and lamp exposure dependant upon product type and conditions. That delay period is typically between 30 seconds and 10 minutes. The length of delay period is also dependant upon the temperature of the wash water used. The presence of a controlled atmosphere, essentially composed of Carbon Dioxide, and the acidic nature of the residual wash water predisposes the microbial growth to adverse physical conditions.

In a further embodiment, the product passes under medium pressure Mercury lamps at a distance of 5 cm-50 cm, typically 10 cm-30 cm distance. The cooling flow of the lamps is adjusted so that some portion of the first period of travel through the apparatus, typically 10 cm-200 cms dependant upon product and throughput, is not subjected to any cooling. When hot water is used, the decontamination step is well established before the product is contacted by the energy generated by the medium pressure lamps and air movement across, over or through the product will have effectively dried the surface. (This is essential when subsequent detoxification is accomplished using defined wavelength Ultraviolet and there is no high temperature energy source to evaporate the moisture from the surface. The surface temperature of the lamps is between 600° C. and 750° C. This causes the residual water to rapidly heat, turn to steam and then evaporate. The result is that all microbial growth is rapidly denatured and the product is effectively sterilized. However, the conditions of operation are such that the temperature rise is limited to the immediate product surface. As a consequence of using either approach, hot water and air drying or the formation of steam at the surface using residual water, the product is only surface sterilized and more than 98% of the volume of each product remains below 45° C. and therefore undenatured: with larger nuts, grains and particularly with fruit and vegetables the percentage of each product undenatured exceeds 99%.

The evaporation of the water and the elevated temperatures also cause any dissolved CO2 to change state back into a gas and this reinforces the inert CO2 atmosphere around the immediate outer surfaces of the product thus minimizing any product oxidation. This further embodiment also ensures that as soon as the product decontamination step is complete, the product rapidly returns to a pH neutral state. By ensuring the product returns as quickly as possible to its normal neutral state further minimizes the possibility of any denaturation or loss of quality. It is also an essential pre-requisite that needs to occur before the completion of the subsequent detoxification stage to prevent reformation of denatured aflatoxin which occurs fastest in acidic conditions following detoxification. It should also be realized that while the decontamination/sterilization step is occurring, either using hot water or steam generation, through a further embodiment to this patent, the product is simultaneously being surface irradiated with shortwave UV-C. We have found that the combined effects of surface acidification using Carbon Dioxide at a pressure of 1-2 atmospheres, with or without acidified wash and rinse waters, surface steam sterilization or hot water treatment and UV-C irradiation produces a synergistic effect over any other single treatment or combination of treatments and leaves all product in either a highly pasteurized state, with many products effectively surface sterilized. We have also been able to control the pressure within the treatment chamber by minimizing the rate at which any gas or air can escape from the system. This also allows us to minimize the loss of any controlled atmosphere most of which can be recycled following its passage through the system followed by any necessary cooling.

We have further shown that it is not essential to use a modified atmosphere to achieve acceptable product whose quality has been minimally affected by oxidation products. The acidic pH can be obtained using wash waters pre-adjusted with 0.005N-001N food grade hydrochloric acid (30-60 ppm) providing that at a suitable point in the decontamination chamber, a final rinse stage needs to contain 10 ppm of food grade sodium hydroxide or other alkali approved for food use to ensure any residual acid has been fully neutralized and the product surface again reaches the desired neutral pH. However the best quality product was always obtained using wash water acidified by the Carbon Dioxide modified atmosphere. It is however obvious to anyone skilled in the art any such neutralization step may not be needed, especially if the product is only being subjected to a decontamination treatment.

We further claim that we have been able to show that keeping the atmosphere moist, at least during the detoxification stage while simultaneously ensuring that the detoxification step is undertaken essentially in a low Oxygen content atmosphere, essentially Nitrogen and Carbon Dioxide or preferably essentially Carbon Dioxide alone, results in a very effective detoxification step with negligible oxidation products formed nor aflatoxin reformation products.

We further claim that the presence of a moist atmosphere, any Ozone formed rapidly reacts with the water in the atmosphere and forms minute quantities of hydrogen peroxide which are rapidly converted back to water and oxygen; as such there is no need to have quartz glass sheets between the product and the lamps.

In a further embodiment, as described with the decontamination step, the pre-washing of the product and moist atmosphere also minimizes the amount of dust in the atmosphere and residual debris on the product. This ensures that under most operational circumstances there is no need for additional cleaning of tubes other than that undertaken in normal maintenance between production shifts.

In another embodiment to this patent, we have been able to use various combinations of defined wavelength UV lamps and achieve comparable detoxification results to those obtained with the medium pressure Mercury lamps but without the consumption of large amounts of electrical energy nor the production of excessive amounts of heat nor the need for expensive, large-scale cooling of the treated product.

Medium pressure lamps give out between 75%-85% of their energy as some form of heat. While the heat component makes a significant contribution to the effectiveness of the decontamination stage, it is not essential for effective detoxification. Providing the UV-A and UV-B outputs are in the range 5 W/cm-100 W/cm and the UV-C output is in the range 10 W/cm-200 W/cm and the total dose for UV-A and UV-B is effectively 300-1000 J/cm and the UV-C dosage is 500-1600 J/cm, detoxification of aflatoxins effectively and quickly occurs within 30-90 seconds. Generally, thicker product or product of large volume need the longest duration exposures for effective detoxification.

Excessive heat is highly detrimental to product quality if product temperature is allowed to rise; we have shown and it has routinely been proven by independent professional taste panels that any product whose mass has been substantially exposed to temperatures above 40° C. negatively affects eating and storage properties particularly in foods such as nuts where there is a naturally high unsaturated fat component.

Taste panel and chemical analyses have shown that under the operating conditions described in British Patent 2388764, 2-Furanmethanol can be formed at the product surface where UV-C and air/oxygen interact. This is noticeable for up to 24 hours after treatment but slowly dissipates thereafter. Vacuum packaging or MAP/CAP reduced its duration. But we have shown that the use of a controlled atmosphere essentially containing Carbon Dioxide and essentially devoid of Oxygen both eliminates its formation nor results in any measurable effect on the levels of unsaturated fats and naturally occurring anti-oxidants in the nut or foodstuff.

Our better understanding of the processes involved in both product decontamination and detoxification and the very different physical conditions needed for optimum decontamination and detoxification to occur have allowed us to better control both processes.

In a final embodiment to this patent, if required or necessary we are able to dynamically control the duration of each process based on ‘real-time’ measurement and monitoring of the microbial contamination and aflatoxin content of each product batch. Information on the level of physical detritus within the product, degree of microbial contamination and aflatoxin levels are fed to the controller of the decontamination and detoxification chamber. The controller can modify product washing conditions and duration, dwell time and total energy output in the decontamination stage and dwell time, spectral distribution and total energy output in the detoxification stage so that it is optimized for each batch to ensure product quality attributes and properties are met but with the minimum of dwell time and exposure needed. It is also capable of eliminating entire processes if washing, decontamination or detoxification are deemed not required for any product or batch.

### BRIEF DESCRIPTION OF THE DRAWINGS

FIG. 1 is a cross sectional view of the combined decontamination and detoxification unit showing the treatment zones and their primary components, according to the invention.

### DETAILED DESCRIPTION OF THE INVENTION

This invention relates to a continuous method and apparatus for simultaneously reducing or eliminating both microbial contamination and mycotoxin contamination, especially aflatoxins and fumonisins, in solid foodstuffs particularly nuts, grains, fruits and vegetables and with particular reference to nuts, such as but not limited to, almonds, pecans, peanuts (actually a legume but widely considered by consumers to be a nut), walnuts, pistachios and Brazil nuts.

It also relates to making use of quantifiable data on said contaminations and modifying said method to maximize throughput, minimize cost and optimize performance. A separate patent application from the same inventor describes a series of processes which are used to, consecutively or concurrently, clean the product, identify flawed, damaged, microbially contaminated and/or aflatoxin containing product, sort product into one or more groups containing similar product and to send the necessary instructions to the apparatus described in this patent application so as to optimize the processing conditions to ensure each product batch will reach at least the minimum process, product and safety standards to satisfy customer requirements.

The following detailed description will describe the various stages the product is subjected to during the decontamination and/or detoxification process, after it has been subjected to the product measurement, process and product monitoring, selection, sortation and control.

The process, equipment and methodology described in this patent application significantly advances the ‘state of the art’ for both the detoxification and decontamination of nuts and other solid food products. For the first time, it effectively minimizes or eliminates both microbial contamination and aflatoxin in a single continuous operation. It optimizes energy utilization and is completely flexible in product type and product throughput that it can handle. Most importantly, from an ecological perspective, it treats product in a way that keeps raw product essentially raw. From a financial standpoint, it also allows both natural and organic product to remain classified and sold as both natural and organic without the need for any additional labeling to identify it as pasteurized or sterilized. Finally, through flexible design, it is undertakes all operations in a fully automatic manner without the need for any human operator intervention.

Four physical processes, namely pH adjustment, controlled heat, defined wavelength light, and controlled refrigeration together with or without the application of a fifth physical process, a modified or controlled atmosphere, are used to achieve all the required processing stages. Each of the physical processes is also capable of independent adjustment or modification to ensure that every aspect of the decontamination and/or detoxification processes are fully flexible and optimisable to suit individual specific requirements. Each physical process is capable of eliciting a decontamination effect. Only one process is capable of eliciting a significant detoxification effect. However, the inclusion of two or more of the other processes produces a synergistic reaction for both decontamination and detoxification processes as well as significantly reducing any loss of product quality during or after treatment.

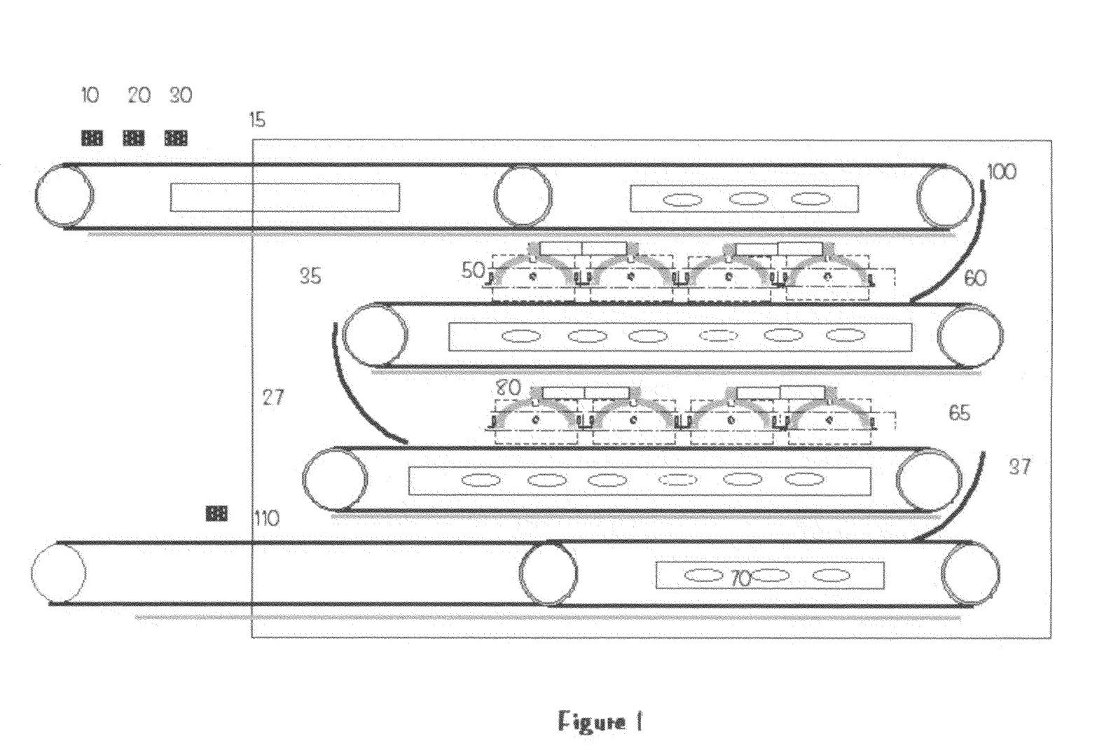

The basis of the process is a modular unit that contains all the necessary technologies so that each unit is fully capable of undertaking each and every required operation (see FIG. 1). This allows the technology to be used by any processor no matter how small their production volume requirements. The basic modular unit can be connected in series, vertically or horizontally. This ensures that the system can occupy any available footprint and be expanded to meet any throughput requirement or contamination treatment level without any loss of performance or efficiency.

We will now explain how each of the physical energies used in both processes achieves a decontamination and/or detoxification effect in their own right, the essential sequence in which each is used and how they interact with each other to produce a synergistic performance beyond that capable of their individual cumulative effects. We will then provide individual examples of decontamination and detoxification, an example of combined simultaneous decontamination and detoxification and a final example of how the modular system can be adapted to meet changing production requirements.

pH adjustment, heat, defined wavelength light, and refrigeration together with or without the application of a fifth physical process, a modified or controlled atmosphere, are used to achieve all the required processing stages.

### Product Decontamination

### pH Adjustment

The first step is the pre-conditioning of the surface of the foodstuff. This is achieved through the pH adjustment stage. As previously stated, many nuts are both allowed to remain in contact with the ground after dropping from the trees; they also stored for long periods untreated in large piles unprotected from the atmosphere before processing. This results in variable amounts of dirt, dust and debris collecting on the surface of the nut. To ensure an repeatable processing environment; all of this needs be removed prior to processing. It is also an essential prerequisite to successful product monitoring, inspection and selection as detailed in our co-pending PCT application.

The washing process can take any suitable form such as but not limited to low, medium or high pressure spraying, immersion, tumbling, continuous low speed centrifugation, etc. In a preferred embodiment, medium pressure spraying in the range 20-80 psi is the preferred methodology. It is can utilize hot or cold water with or without additives such as wetting agents, surfactants, detergents and pH adjusters. This will vary both by the level of cleaning required and any local regulatory limitations or exclusions.

In a preferred embodiment, the washing stage is a 3-stage process utilizing the same medium pressure sprayers. Stage 1 utilises clean water to remove the majority of any adhering debris, dirt or detritus. Stage 2 is a repeat of stage 1 but, if necessary, with the addition of a suitable wetting agent and/or detergent to remove any residual adhering material. Optionally, the washed product can pass over or through a monitoring station to determine the cleanliness of the product surface using any suitable method such as IR inspection or UV fluorescence and the washing process can be modified or adapted to ensure maximum effectiveness.

In an embodiment, Stage 3 of the washing operation uses the same spraying equipment used in stages 1 and/or 2 but the cleaning solution used is pH adjusted. The reason for this is that the microbial contamination population on any foodstuff varies and we have found that the contaminating organisms can be more successfully eliminated if they are pre-treated with a solution which results in a modification to the surface of the foodstuff so that it is extreme relative to the organisms encountered (see Table 1). For example, most pathogenic organisms found on almonds, such as Salmonella species and E. coli grow optimally at pH 6.5-7.5. The same applies to spoilage organisms such as bacteria and yeasts. By adding 0.001N Hydrochloric acid to the stage 3 rinse water, with or without a suitable wetting agent, the immediate surface of the product becomes a hostile environment to the contaminating organisms and we have shown that providing this pH adjustment can be maintained for a minimum period of 30 seconds, preferably 60-180 seconds, there is a measurable decline in total viable counts. Not all products require a wetting agent. For example, ridged or contoured surfaces such as nuts and some vegetables or surface hairs such as those found on fruits such as peaches or gooseberries will easily retain water droplets. Others such as apples and tomatoes have very smooth surfaces and/or have waxy cuticles and will requiring wetting agents to retain a film of moisture over their external surfaces. Obviously the possible range of additives is large dependent upon the micro-organism population present. However, for most purposes we have found that Hydrochloric acid is most suitable, especially as it can easily be neutralized with weak Sodium Hydroxide solution to form Sodium Chloride, a totally naturally occurring compound. We have also found that additives such as Hydrogen Peroxide, Ozone, and various forms of Chlorites, Hypochlorites and similar oxidizing disinfecting agents do have a variable but essential positive effect on residual microbial numbers. However, they negatively impinge on product properties, accelerate oxidation reactions and in many instances have variable performance as they are rapidly inactivated by any residual debris remaining on the foodstuff surface.

Finally, to ensure that any decontamination treatment is consistently effective, a film of moisture must be maintained for at least part of any subsequent treatment. However, to maintain product quality, it is essential that any moisture is confined to the extreme product external surfaces and little or none penetrates into the body of the foodstuff. We have found that the product washing methodology described here works best if there is a short delay between the completion of the washing stage and the commencement of the decontamination and/or detoxification stages. This can be any suitable time duration and is determined by product characteristics; for example almonds required a minimum of 30 seconds delay and a maximum of around 10 minutes. Any longer than this would cause moisture to be absorbed by the nut; it also caused the seed coat to start to lift from the body of the nut—both undesirable characteristics. However, a film of physically adhering wash water is essential for an effective decontamination stage.

### Heat

Once any dirt, debris or detritus has been removed from the product as detailed in the previous section, two further physical treatments are applied, one of short-term duration the other somewhat longer. Both are achieved using the same technology.

Pasteurisation and sterilisation of foodstuffs using steam is well-known and several such approaches have been previously detailed in this application. However almost all such techniques rely on steam in one of several forms such as pressurized, superheated, dry steam, etc., being formed through some heating mechanism and the formed steam being introduced into or over the foodstuff with any pasteurization or sterilization effect resulting from the energy derived from the latent heat of the steam as it condenses on the product surface.

There are two major drawbacks to such treatments. Firstly, they are extremely energy inefficient as considerable energy is used in generating the steam and lost in maintaining it in such form to reach the product. Secondly, there are rapid temperature rises on and in the treated foodstuff due to the energy from the latent heat. Making the steam dry allows product to be cooled quicker than a wet steam environment, however dry steam causes considerable surface and sub-surface denaturation. As a consequence, while the various treatments are effective in reducing microbial numbers, they also ‘kill’ the product as they inactivate essential enzymes and denature proteins. This makes it difficult for products treated in such a manner to be classified or labelled as native or organic. We have found that an alternative approach surprisingly produces a better decontamination performance than conventional steam based systems. More importantly, it achieves the required level of decontamination without denaturing the product. The alternative approach involves either generating the steam solely at the surface of the product using the heat generated from the medium pressure defined wavelength UV-lamps or using hot water which has less energy but is more easily evaporated. This approach ensures the most efficient use of energy combined with very effective decontamination. The previously described washing phase results in an even film of moisture around the foodstuff. The wash water, pH adjusted with either dissolved Carbon Dioxide and/or inorganic mineral acids such as 0.001N Hydrochloric acid, forces an extreme change in the immediate environment around the microbial contaminants. We have also shown that the delay period between the completion of the washing stage and the commencement of the treatment stage allows all microbial vegetative cells and to a lesser extent, most spores, to become fully turgid and this further enhances the effectiveness of the treatment stages. Where hot water is used, this is applied within the final rinse and after preferentially after the wash treatment is completed.

When the washed product enters the treatment chamber, the first part of the chamber is not subjected to any cooling and the Infra-Red component output from the lamps causes a rapid temperature rise at the product surface (ambient to 100° C.) in less than 10 seconds. This in turn causes the water film to turn to steam and evaporate from the surface of the foodstuff. We have found that providing the temperature rises to in excess of 80° C., the decontamination effect is essentially the same as reaching 100° C. The increased humidity close to the product surface also acts to slow any temperature increase within the nut. We have been able to show that the temperature increase 2 mm into the body of most foodstuffs never exceeds 50° C. By subjecting the product to effective cooling and undertaking the product cooling in an environment with much lower humidity, the temperature at the product surface rapidly (less than 10 seconds) drops below 45° C., thus very effectively maintaining the native state of the foodstuff.

Where there is little or no generation of heat, for example when only lower pressure, defined wavelength UV lamps are used for the generation of short wave UV-C as well as UV-A and UV-B, control of air flows over the product effectively cause residual moisture evaporation.

### Defined Wavelength Light

The use of pH adjusted wash waters and Infra-Red energy combine to produce effective product decontamination. However, we have been able to show that the use of short-wave length in combination with both of the other technologies synergistically improves the decontamination performance and effectiveness.

The use of shortwave energy as a decontamination medium has been well-known for almost a century. There are also many teachings of combinations of shortwave UV and other technologies such as Ozone, Hydrogen Peroxide and Ultrasound used as effective decontamination media especially for difficult foodstuffs such as wet product such as meat and convoluted product such as vegetables. Unfortunately, UV energy is a ‘line of sight’ energy. This means that the UV energy has to strike the contamination source to affect a decontamination effect. It is also a non-penetrative energy, i.e. it is rarely capable of penetrating below the immediate product surface, so unless the product orientation is changed, hidden surfaces are not decontaminated; hence the need for other energy sources such as hot water or steam to access such hidden surfaces.

One additional problem associated with the use of shortwave UV as a decontaminating medium is the presence of debris, dirt and detritus on the surface of the foodstuff. If this masks the contaminated surfaces, the UV will sterilize the surface of the dirt but will not penetrate to the contaminated product surfaces. This is a common problem with many decontaminating media; they lose their available decontaminating energy decontaminating the dirt and detritus. Chemical based decontaminating agents such as chlorine based liquids or oxidizing agents such as peroxides can also negatively affect product properties especially its important organoleptic attributes. The same is also true of steam-based treatments which can both denature, induce hydrolytic changes and the elevated temperatures can induce auto-oxidation reactions. There are also so-called ‘actinic’ reactions that can be induced by the use of short-wave UV energy at acidic pH levels, especially if the short-wave energy source used also generates Ozone, a strong oxidizing compound.

Surprisingly we have been able to synergistically improve decontamination performance and virtually eliminate any deterioration in product properties by combining and sequencing treatments using pH adjustment, heat and defined wavelength UV light. Minimising the duration of each treatment ensures no product deterioration, combining the treatments produces a decontamination effect far greater than the combined performance of the individual technologies.

We have also been able to show that the use of a modified atmosphere or controlled atmosphere, especially Carbon Dioxide and Nitrogen and preferentially primarily Carbon Dioxide, virtually completely eliminates any deterioration of product properties. For most foodstuffs decontaminated with one or more of the above mentioned technologies, a modified atmosphere is not essential to achieve suitable decontamination performance whilst minimizing any effects on resultant product properties. However, as detailed later, it is an essential requirement for effective detoxification without affecting product properties.

### Refrigeration

Keeping reaction temperatures as low as possible has been shown to reduce physical and chemical changes to product properties. Most reactions which deteriorate foodstuff properties (oxidation and/or hydrolytic) are doubled for each 10° C. increase in product temperature. With the exception of the use of the Infra-Red induced heating stage or hot water at the product surface, all reactions and treatments take place on/in product which is kept at 10° C. or lower through the processing operations.

Better product organoleptic characteristics, especially those which had high unsaturated fat contents, were always obtained where temperatures were kept lowest, Oxygen content minimized or eliminated and exposure times for each treatment kept to a minimum. Prior product monitoring, measurement and sortation using the techniques and equipment in the co-pending PCT application which allowed optimized selection of treatment step conditions always produced the best product.

### 2. Product Detoxification

(unless otherwise stated, the same conditions as detailed for product decontamination are used for product detoxification).

For all the reasons previously discussed, effective and reproducible product detoxification is much more difficult to achieve than product decontamination, moreover detoxification of essentially solid foodstuffs are the most difficult of all. Aflatoxins are heat stable and are unaffected by refrigeration or freezing. Those present in solid foodstuffs are also immune to most chemical treatments. Any that do result in some degree of detoxification usually degrade the product properties as well.

However, we have been able to successfully demonstrate a combined methodology that does, very effectively, detoxify solid foodstuffs without affecting product organoleptic properties or keeping qualities, is able to process product at manufacturing lines speeds and, most importantly, does not denature the product in any way so that alternative or additional labeling requirements are avoided.

### pH Adjustment

Where product is to be concurrently or sequentially decontaminated as well as detoxified, prior treatment of product to adjust its pH is needed. Where product is only to be detoxified, any wash step is only needed to clean product surfaces. The same effect can also be obtained through other methods of physical cleaning such as brushing, air blowing, winnowing, etc. If pH adjustment has been used in the product rinse phase or Carbon Dioxide has been used as a modified atmosphere in conjunction with a moist or wet foodstuff, it is essential that, after detoxification treatment is complete, the product is made pH neutral or even slightly alkaline so as to avoid any recombination of denatured aflatoxins. We are cognisant of the greater awareness of this effect in many other treatments (e.g. Price and Jorgensen, 1985, Fandohana et al, 2005) primarily foodstuffs treated in any form of aqueous phase. By adding this small further step, we believe we have added very significant stability to treated products, enhancing our already achieved level of product detoxification as we have not been able to demonstrate any subsequent recombination of aflatoxin in any of the product we have successfully detoxified.

As has been previously stated, any pH adjustment results in an acidification of the extreme product surface only. The use of the Carbon Dioxide atmosphere for detoxification is merely to eliminate Oxygen from the immediate product environment so as to minimize the potential for formation of oxidation products or peroxide compounds. With aflatoxins likely to be distributed throughout the mass of any contaminated product, any surface acidification is unlikely to have any significant effect on either detoxification performance or effectiveness or resultant product property modification or deterioration. However, it does appear to prevent the commencement of auto-oxidation processes which are known to produce (in part) acidic breakdown products.

We have also utilized the step to provide a final repeat decontamination step as the product exits from the treatment chambers. This has shown to be very effective in further reducing or eliminating residual levels of microbial contamination ensuring that treated product exiting the treatment chamber is both effectively decontaminated and detoxified. Where this step occurs, it is essential to eliminate any residual free moisture accumulating on the product surface.

### Heat

As previously stated, aflatoxins are extremely heat stable. In solid or essentially solid foodstuffs, the ineffectiveness of heat treatments of any form has been well demonstrated over many decades. The more the foodstuff can be suspended into an aqueous phase, the more components that can be added to it to adjust product pH, (Méndez-Albores, 2004; Elias-Orozco, 2002). The greater the product alkalinity, the more successful the detoxification using heat. However in all cases, the use of heat in any form and/or the addition of chemicals significantly lowers product quality and acceptability. Additionally, the product is denatured by the treatment and loses its native and/or organic status. This can have major financial implications.

For product primarily subject to a detoxification treatment only, we have therefore eliminated most of the heat generation and energy input by eliminating the use of medium pressure and high pressure Mercury lamps and substituting a number of defined wavelength UV emitting lamps which produce little or no heat. Subsequently, within this new system methodology and configuration we have been able to optimize any required decontamination by utilizing a combination of hot water treatment with high output low pressure shortwave UV emitting lamps, except as previously stated, where the pH adjustment stage is utilized or a product has been subjected to an atmosphere of, essentially, Carbon Dioxide and the atmosphere is high humidity and/or the product has a high moisture content and/or a high water activity.

### Defined Wavelength Light

We have shown that the use of defined wavelength energies are the essential components in our non-chemical approach to detoxification. Medium pressure Mercury lamps emit between 75%-85% of their energy as some form of heat. While the heat component, as we have previously detailed, makes a significant contribution to the effectiveness of the decontamination stage, it is neither essential nor effective for solid product detoxification. Our earlier work using the broadband UV emissions derived from medium pressure Mercury lamps has repeatedly been successful in reducing/minimizing aflatoxin contamination, it had not been possible to eliminate the UV-C component. British Patent 2388764 used a glass partition to separate the UV lamps from the product being treated. We used a variety of suitable material which allowed emitted UV-A and UV-B to pass through but prevented any UV-C emissions from reaching the product in to quantify the effectiveness of UV-A and/or UV-B emissions to detoxify solid foodstuffs. While we were always able to demonstrate effective detoxification with or without the use of a UV-C absorbing material, we found that, surprisingly, although UV-C is known to have little or no penetrative energy, when UV-C was prevented from reaching treated product surfaces, the rate of detoxification was always significantly lower than treatments which used all 3 UV wave bands. As yet we have not been able to elucidate the reasons but believe that as the UV-C component makes up 30%-50% of the UV emissions from medium and high pressure Mercury lamps, part of that energy may undergo a spectral wavelength shift on striking the product surface to a longer wavelength resulting in a higher dose of UV-A and/or UV-B penetrating the product than the theoretically calculated maxima. Alternatively, the UV-C component may be eliciting a reaction at or just under the product surface that enhances the performance of the UV-A and/or UV-B components.

Using lamps which emit solely in the UV-A and UV-B wavelengths, providing the UV-A and UV-B outputs are in the range 5 W/cm-100 W/cm and the total dose for UV-A and UV-B is effectively at least 300-1000 J/cm, applied as a single continuous dose, detoxification of aflatoxins effectively and quickly occurs within 50-160 seconds. Generally, thicker product or product of large volume and/or denser mass needed the longest duration exposures for effective detoxification.

Where combined medium pressure Mercury lamps are used and in addition to the UV-A and UV-B emissions, the UV-C output is in the range 10 W/cm-200 W/cm and the product receives a total UV-C dosage of 500-1600 J/cm, detoxification greater than 96% occurs in 30-90 seconds.

### Refrigeration

As with product decontamination, refrigeration is essential for two purposes, prevention of product surfaces from reaching temperatures that would result in denaturation of product components, especially proteins and to minimse the initiation of oxidation or hydrolytic reactions that would reduce product quality attributes and deplete natural product anti-oxidants. For detoxification reactions undertaken in the absence of medium pressure lamps emitting a high Infra-Red output, refrigeration requirements are small as UV wavelengths emit very little heat and product surface temperatures remain low. However, it is always beneficial to keep product surface temperatures below 10° C. and preferentially below 5° C. to minimise loss of product quality. Accordingly, we have designed system treatment chambers so that sufficient refrigerated air, or preferentially a modified atmosphere of essentially Carbon Dioxide, is circulated to ensure product surfaces are kept as low as possible and never to reach a temperature that would cause denaturation of any product component, especially those that effect nutritive value, product quality attributes or natural/organic status.

### Modified or Controlled Atmosphere

British Patent 2388764 teaches that the use of a controlled atmosphere is essentially to change the pH at the surface of the product to a more acidic one and enhance the decontamination effect. In our system, while such surface pH modification does have a measurable effect, the use of the UV-C and the generation of steam at the product surface are far more effective, producing an essential sterile product surface. It also teaches that ‘effective detoxification can take place either in a modified or unmodified atmosphere’. We have found that while the presence or absence of an unmodified atmosphere has little effect on the efficiency of a detoxification reaction, the absence of a modified atmosphere does have a measurable and negative effect on product keeping quality and product organoleptic attributes. This degradation also appears to in direct proportion to the level of UV-C energy emitted. As a consequence, wherever practical, an oxygen reduced atmosphere needs to be used, preferentially one essentially oxygen-free and predominantly composed of Carbon Dioxide.

Finally British Patent 2388764 also teaches that ‘passing the circulating air through a dry filtration system, significant amounts of dust can be removed’. We have found that such a step is unnecessary where either/both product rinsing and steam generation stages are implemented.

Finally we will describe three examples of the described technology.

### Example One

### Decontamination of Commercial Almonds:

(This example uses the surface steaming methodology combined with shortwave UV and product acidification).

Commercial almonds, variety Non-Pareil, pass into the manufacturing environment at a throughput rate of 2000 lbs/hour. They are exposed to 3 separate but continuous rinse stages. Stages 1(10) and 2(20) consist of conventional product spray cleaning heads, each at a pressure of 15-60 lbs/in2 and a volume of between 5-20 gallons/hour. Potable water, with/without chlorination and/or food approved surfactants, is sprayed on the passing product in stages 1 and 2. If the product is fed along a linear conveyor (15, 25), there is a fall in the conveyor (17,27) of between 3″-6″ approximately halfway through each washing stage to ensure all product surfaces are equally treated. If product is gently rotary tumbled or cascaded through the rinse systems, then an even wash/rinse is naturally achieved. The 3^{rd} rinse stage (30) is a repeat of stages 1 and 2 but uses potable water acidified to pH 3.5 using 0.001N food grade Hydrochloric acid. Product then passes either into an intermediate storage bin or along a delay conveyor (35) for 60 seconds so that any excess water is allowed to drain but the product remains moist.

The washed, surface moist product pass into the light treatment chamber at entry point (40) and along the service conveyor (35). The product then passes along an infeed conveyor (60) in a monolayer configuration under a number of medium pressure Mercury lamps (50). The number of lamps depends on required speed of treatment and actual product throughput rate. In this configuration, for a moderately contaminated product and a throughput rate of 2000 lbs/hour, 8 lamps at 15″ centres are sufficient. Based on these operating parameters the system calculates the distance the almonds need to pass under the lamps before the almonds are exposed to a refrigerated atmosphere. Under the Mercury lamps without refrigeration, the surrounding atmosphere and the surface temperature of the nuts rapidly rises causing the residual moisture on the nut surface to turn rapidly to steam and evaporate from the surface. Throughout the passage under the lamps the product surface is also exposed to high energy dose of shortwave radiation, where the UV-C output is in the range 10 W/cm-200 W/cm and the product receives a total UV-C dosage of 500-1600 J/cm, resulting in a decontamination greater than 99.99% occurring within in 30-60 seconds.

From the calculated point along the conveyor, refrigerated air, preferably at 10° C. or less, is allowed to percolate through the nut from underneath the perforated conveyor bed (65) via a series of distribution ducts (70). This has three functions; firstly to prevent the temperature of the body of the nut from rising to a temperature which would cause any component denaturation or deterioration in product properties; secondly to stop the formation of any more steam once the surface moisture film had evaporated. Thirdly, the lower air temperature will cause the surrounding atmosphere to remain slightly moist.

When the product is decontaminated in the preferred reduced Oxygen atmosphere, and more preferably of essentially 100% Carbon Dioxide, the higher than atmospheric pressure within the treatment chamber will allow the gaseous Carbon Dioxide to react with the water vapour forming acidic Carbonic Acid and with the nut now being the coolest part of the system, small amounts of Carbonic Acid condense on the nut surface adding to the hostile environment for any residual micro-organisms. The Carbon Dioxide, Carbonic Acid, and to a lesser extent, water vapour prevent oxidation or hydrolytic reactions in or on the product from occurring. Excess amounts of heat generated by the medium pressure lamps is exhausted from the upper part of the system through centrifugal fans (80). The rate of hot atmosphere extraction is automatically controlled by monitoring both the surface temperature of the lamps and the amount of current they draw. The extracted gases pass through a suitable cooling system (90) which allows the heavier Carbon Dioxide (if used) to be separated and recycled, any useful heat to be extracted while other waste gases are vented to exhaust.

On reaching the end of the first surface conveyor, the product falls down a simple narrow thickness chute (100) which retains the nut orientation. This ensures the exposed nut surface now becomes the underside and is further rapidly cooled. The previously unexposed surface is now exposed to the shortwave UV and product decontamination is completed. The lamp configuration on the lower level of the treatment chamber is essentially a mirror image of the upper chamber. As with the product infeed, the final length of perforated conveyor is uncooled to ensure the product surface is dry before exiting the treatment chamber (110). This also forces any residual Carbonic Acid to revert to water vapour and Carbon Dioxide. For decontamination only applications, all of the medium pressure Mercury lamps can be replaced with low pressure, high output shortwave UV-C lamps, except those few at the beginning and end of the treatment chamber used to raise the temperature at the surface of the product to turn water to steam. The number of low pressure lamps needed will vary with application but the total UV dosage will be similar to that derived from the medium pressure lamps. The use of low-pressure lamps will also reduce the system refrigeration requirements. The above example uses essentially a vertically configured, gravity fed system, highly suitable for small nuts. However, it will be obvious to anyone skilled in the art that any combination of vertical, horizontal or rotary system configuration can be used to allow the selected product to traverse the treatment chamber. Also, any number of medium pressure and low pressure lamps can be used providing there is
a) sufficient energy to rapidly increase the temperature of the atmosphere immediately adjacent to the product surface to allow the formation of steam from the moisture film surrounding the product,
b) sufficient shortwave UV energy to provide the necessary continuous minimum dose needed to disinfect the product surface and
c) sufficient heat to ensure the exiting product is dry and
d) any residual Carbonic Acid has evaporated.

Although not shown in the accompanying diagrams, it is obvious that the conveyor surfaces carrying the contaminated product should be exposed to their own suitable cleaning and decontamination regimen to ensure cross-contamination or recontamination of product does not occur. A suitable regimen and methodology is detailed in U.S. Pat. No. 7,234,586.

### Example Two

### Detoxification of Commercial Almonds:

The removal of Alflatoxins primarily requires medium and longwave Ultraviolet light rather than the shortwave UV used for decontamination. However, the same system configurations used for decontamination can be used for detoxification with some minor modifications. Because of the greater penetrative capabilities of medium and longwave UV, it is not essential to undertake the wash and rinse regime detailed for decontamination. However, operating conditions need to ensure that dust is eliminated from the atmosphere as this tends to become electrically charged within the treatment chamber and be deposited on the lamp glass causing both reduced lamp efficiency and requiring frequent cleaning. This is most easily achieved by adding moisture to the circulating atmosphere, if not incorporating the wash/rinse regime which does not need the pH adjustment step and significantly benefits from its preferential omission. The infeed conveyor (35) is of sufficient length and speed to ensure adequate time for product to sufficiently drain.

For treating 2000 lbs product per hour, 8 lamps, preferentially in 2 blocks of 4, are sufficient. The vertical arrangement shown in FIG. 1 is the preferred configuration. For each additional 2000 lbs, a minimum of 4 additional lamps are needed.

The lamps can be either the same medium pressure Mercury broadband UV emitters used for decontamination or preferentially they can use lamps which emit solely in the UV-A and UV-B wavelengths, providing the UV-A and UV-B outputs are in the range 5 W/cm-100 W/cm and the total dose for UV-A and UV-B is effectively at least 300-1000 J/cm, applied as a single continuous dose. Under these conditions, detoxification of aflatoxins is extremely effective and quickly occurs within 50-160 seconds. Generally, thicker product or product of large volume and/or denser mass need longer duration exposures for effective detoxification. However for almonds at 2000 lbs/hour throughput, almost 100% detoxification occurs within 60 seconds.

Because defined wavelength lamps produce energy in a narrow but tightly defined band and exclude unwanted wide sectors of the spectrum, such individual lamps produce much lower total radiance than the much less specific medium pressure lamps. With the lamps currently available at least 4 such lamps are needed in place of each broadband lamp. Where this occurs, the footprint of the chamber is increased to accommodate these lower power lamps. However, while their individual total radiance is lower, their efficiency is greater so total dwell times are not significantly increased.

If medium pressure lamps are used then a refrigeration regime similar to that used for decontamination is needed to prevent product oxidation occurring at the surface. If the lamps are solely UV-A and UV-B emitters then refrigeration requirements are minimal. Two very specific parameters are needed to ensure effective detoxification, the prevention of aflatoxin recombination and the maintenance of optimum product quality attributes. The atmosphere within the chamber needs to minimize the possibility of oxidation and/or hydrolytic reactions as many of these breakdown products tend to be acidic in nature and contribute to a change in the pH of the product. The use of an Oxygen depleted, preferably Carbon Dioxide rich atmosphere as previously described for decontamination is most effective. The preferred elimination of broadband lamps minimizes the potential for such reactions to occur. As the product passes under the lamps (??), Carbon Dioxide, preferably at 10° C. or less, is allowed to percolate through the nut layer from underneath the perforated conveyor bed (65) via a series of distribution ducts (70). Unlike the conditions for decontamination, it is essential that the air is kept as dry as possible. Aflatoxin recombination is most prevalent under acidic conditions. By keeping the air dry, little of no Carbon Dioxide will dissolve to form Carbonic Acid and little or no moisture will form on the surface of the nuts.

Secondly, by ensuring that the surface of the treated product is at least pH neutral and preferentially, slightly alkaline, no aflatoxin recombination has been shown to occur. If broadband UV emitters have been used and/or the product has been subjected to a wash/rinse regimen then immediately prior to exiting the treatment chamber (110) or immediately after, whichever is most practical for the operation/product, the product surface is sprayed with a fine mist solution of potable water containing a weak food approved alkali, preferably a mixture of isotonic sodium chloride and 0.001N food grade sodium hydroxide, either to neutralize any residual food grade hydrochloric acid that may remain or to impart a slightly alkaline pH to the product surface. The apparatus used is the same as described for the wash/rinse steps but the volumes used are very much smaller. For products with low water activity or neutral pH, the amount needed is extremely small, less than 0.1 ml per 10 grams of product. The solution rapidly evaporates from the product surface so there is no increase in product moisture content.

We have found that such a step also appears to preclude aflatoxin reformation in product detoxified in neutral conditions using narrow band UV-A and UV-B emitters.

Although UV-A and UV-B have much greater penetrative power than UV-C, the same product handling and manipulation as used for decontamination is preferentially adopted so that both sides of the product are evenly treated and full detoxification occurs quicker than with a product that retains a single orientation.

### Example Three

### Continuous Simultaneous Decontamination and Detoxification of Commercial Almonds:

This example uses the alternative combination treatment of hot water and shortwave UV generated from both medium and low-pressure lamps. The apparatus and methodology used to achieve the combined treatment is effectively the same as used for detoxification but with minor modifications. As with the previous examples, while we describe a specific system and lamp configuration, it will be obvious to anyone skilled in the art that the same effects can be achieved by ‘mixing and matching’ the lamp types providing the minimum lamp output in each waveband, minimum total radiance and minimum exposure time are achieved or exceeded. Similarly vertical and horizontal system configuration can be mixed. Finally, the method of moving the product through the system can also be mixed between horizontal conveyoring, vertical cascading using gravity or rotary transfer, providing the product remains preferentially as a monolayer and all sides of the product receive the minimum required treatment.

Commercial almonds, variety Non-Pareil, pass into the manufacturing environment at a throughput rate of 1000 kgs/hour. They are exposed to 3 separate but continuous rinse stages. Stages 1(10) and 2(20) consist of conventional product spray cleaning heads, each at a pressure of 15-60 lbs/in2 and a volume of between 20-100 litres/hour. Potable water, with/without chlorination and/or food approved surfactants, is sprayed on the passing product in stages 1 and 2. If the product is fed along a linear conveyor (15, 25), there is a fall in the conveyor (17,27) of between 3″-6″ approximately halfway through each washing stage to ensure the product is rotated and all product surfaces are equally treated. If product is gently rotary tumbled or cascaded through the rinse systems, then an even wash/rinse is naturally achieved.

The 3^{rd} rinse stage (30) is a repeat of stages 1 and 2 but uses hot potable water, in excess of 80° C. and preferentially in excess of 95° C., acidified to pH 3.5 using 0.001N food grade Hydrochloric acid. Product then passes along a delay conveyor (35) for between 30-180 seconds, preferentially 60 seconds, so that any excess water is allowed to drain but the product remains moist.

The washed, surface moist product pass into the light treatment chamber at entry point (40) and along its service conveyor (35). The product then passes along an infeed conveyor (60) in a monolayer configuration, initially under a number of medium pressure Mercury lamps (50), preferably 2 and an air flow of between 400 m3/hr and 2000 m2/hr sourced from ambient air. The decontamination then continues using low pressure, high output Mercury lamps emitting predominantly shortwave UV-C. The number of lamps depends on required speed of treatment and actual product throughput rate. In this configuration, for a moderately contaminated product and a throughput rate of 1000 kgs/hour, 24 lamps at 30 cms centres have been shown to be sufficient. Based on these operating parameters the system calculates the horizontal distance the almonds need to pass under the lamps to ensure the moisture on the surface of the product has been evaporated, without the formation of denaturation products prior to the almonds being exposed to a refrigerated atmosphere. Under the Mercury lamps without refrigeration, the surrounding rapidly moving atmosphere and the surface temperature of the nuts causes the residual moisture on the nut surface to rapidly evaporate from the surface. Following this initial evaporation step and throughout the remainder of its passage through the treatment chamber, the product surface is exposed to UV-A and UV-B wavelengths with the UV-A and UV-B outputs in the range 5 W/cm-100 W/cm so that the total dose for UV-A and UV-B is effectively at least 300-1000 J/cm, applied as a single continuous dose to each side of the product. Under these conditions, detoxification of aflatoxins is extremely effective and quickly occurs within 50-160 seconds. Generally, thicker product or product of large volume and/or denser mass need longer duration exposures for effective detoxification. However for almonds at 1000 kgs/hour throughput, almost 100% detoxification occurs within 60 seconds.

During its travel through the treatment chamber, the product is also exposed simultaneously to a high energy dose of shortwave radiation, where the UV-C output is in the range 10 W/cm-200 W/cm and the product receives a total UV-C dosage of 500-1600 J/cm, resulting in a decontamination greater than 99.99% occurring within in 30-60 seconds. From the calculated point along the conveyor, a refrigerated atmosphere, preferably an Oxygen depleted atmosphere, more preferentially a Carbon Dioxide rich atmosphere, preferably at 110° C. or less, is allowed to percolate through the nut layer from underneath the perforated conveyor bed (65) via a series of distribution ducts (70). This prevents the temperature of the body of the nut from rising to a temperature minimizing/eliminating any component denaturation or deterioration in product properties.

Excess amounts of heat generated by any medium pressure lamps are exhausted from the upper part of the system through centrifugal fans (80). The rate of hot atmosphere extraction is automatically controlled by monitoring both the surface temperature of the lamps and the amount of current they draw. The extracted gases pass through a suitable cooling system (90) which allows the heavier Carbon Dioxide (if used) to be separated and recycled, any useful heat to be extracted while other waste gases are vented to exhaust.

On reaching the end of the first treatment conveyor, the product falls down a simple narrow thickness chute (100) which retains the nut orientation. This ensures the exposed nut surface now becomes the underside and is further rapidly cooled. The previously unexposed surface is now simultaneously exposed to all UV wavelengths and product decontamination and detoxification is completed. The lamp configuration on the lower level of the treatment chamber is essentially a mirror image of the upper chamber.

Unlike the conditions for decontamination alone, it is essential that once the surface evaporation stage is completed, the remaining air atmosphere is kept as dry as possible. Aflatoxin recombination is most prevalent under acidic conditions. By keeping the air dry, little of no Carbon Dioxide will dissolve to form Carbonic Acid and little or no moisture will form on the surface of the now dry nuts.

Secondly, by ensuring that the surface of the treated product is at least pH neutral and preferentially, slightly alkaline, no aflatoxin recombination has been shown to occur. If broadband UV emitters have been used and/or the product has been subjected to a wash/rinse regimen then immediately prior to exiting the treatment chamber (110) or immediately after, whichever is most practical for the operation/product, the product surface is sprayed with a fine mist solution of potable water containing a weak food approved alkali, preferably a mixture of isotonic sodium chloride and 0.001N food grade sodium hydroxide, either to neutralize any residual food grade hydrochloric acid that may remain or to impart a slightly alkaline pH to the product surface. The apparatus used is the same as described for the wash/rinse steps but the volumes used are very much smaller. For products with low water activity or neutral pH, the amount needed is extremely small, typically less than 0.1 ml per 10 grams of product. This small amount of added solution rapidly evaporates from the product surface so there is no increase in product moisture content.

As with the product in-feed, the final length of perforated conveyor is not cooled to ensure the product surface is dry, preferentially before exiting the treatment chamber (110), soon after if this is not practical. The use of low-pressure lamps will also reduce the system refrigeration requirements.

As previously stated, both product decontamination and product detoxificatin can be achieved using predominantly, if not exclusively low pressure, high output shortwave UV-C lamps. The number of low pressure lamps needed will vary with application but the product will be subjected to a total UV dosage similar to that derived from applications using the medium pressure lamps. Product detoxification can also be achieved, with some or most of the medium pressure Mercury lamps replaced with low pressure, high output, narrow band, long wave UV-A and medium wave UV-B wavelengths with both the UV-A and UV-B outputs in the range 5 W/cm-100 W/cm, providing that the total dose for UV-A and UV-B is effectively at least 300-1000 J/cm, applied as a single continuous dose to each side of the product.

### References Cited

### Patents:

British Patent 1 117 573, CSIR, 1968
British Patent 2 388 764, Newman, 2006
Eur. Pat. App 1 533 033, Yabe K et al, 2005
PCT Patent Application WO2005021740, 2002
US Patent Application 20050112255, Tottenham D., 2005
US Patent Application 20050147594, Karmen D et al., 2005
US Patent Application 20060029704, Long D. et al., 2006
U.S. Pat. No. 4,035,518, Carmona, 1977
U.S. Pat. No. 5,082,679, Chapman, 1994
U.S. Pat. No. 5,229,007 Ellenberger, 1993
U.S. Pat. No. 5,230,160, Gross, 1993
U.S. Pat. No. 5,498,431, Linder, 1996
U.S. Pat. No. 5,597,597, Newman, 1997
U.S. Pat. No. 6,294,211, Yuan et al, 2001
U.S. Pat. No. 7,234,586, Newman, 2007
W. German Patent 1 914 095, Hanssen and Bahlsen, 1970

### Other References:

T. Altug, A. E. Yousef and E. H. Marth, ‘Degradation of Aflatoxin B1 in dried figs by sodium bisulphite’. Journal of Food Protection, 53(7) 581-582, (1990)
K. Bencze and F. Kiermeier, ‘UV Irradiation of aflatoxins in solid phase’ Zeitchrift fur Lebensmittel, 148 (5), 279-285, (1972)
O. L. Brekke and A. C. Stringfellow, ‘Aflatoxin in corn: a note on ineffectiveness of several fumigants as inactivating agents’, Cereal Chemistry, 55 (4) 518-520, (1978)
L. Goldblatt and F. Dolear, Pure and Applied Chemistry, 49, 1759-1764, (1977)
H. Maeba et al., ‘Destruction and detoxification of aflatoxins with ozone’, Journal of Food Science, 53(2), 667-668, (1988)
S. E. Magella and A. H. Hafez, ‘Detoxification of aflatoxin B1 by acidogenous yoghurt’, Mycopathologica, 77(2) 89-91, (1982)
M. Manabe and S. Matsuura, ‘Degradation of added aflatoxin during miso fermentation’, J. Food Science and Technology (Japan) 19 (6), 275-279, (1972)
Mendez-Albores J. A. et al., An extrusion method for making the dough (masa) for corn tortillas. J. Science of Food & Agric, Volume 84(12),1611-1619, (2004)
R. L. Price and K. V. Jorgensen, Effects of Processing on Aflatoxin Levels and on Mutagenic Potential of Tortillas made from Naturally Contaminated Corn J. of Food Science 50 (2), 347-349 (1985)
J. L. Rasic, M. Skrinjar and S. Markov, ‘Detoxification of aflatoxin B1 by yoghurt, lactic and acetic acids’, Food Biotechnology, 4(1) 608, (1990)
T. Shantha and V. Sreenivasamurthy, ‘Photo-destruction of aflatoxin in groundnut oil’, in Fats and Oils in Food Products and their preparation, pp 103-105, Symposium, Food Research Institute, Mysore, India (1978)
O. L. Shotwell et al, ‘Aflatoxin occurrence in some white corn’ Cereal Chemistry, 52 (5) 670-677, (1975)
W. E. Steiner, R. H. Rieker and R Battaglia, ‘Aflatoxin contamination in dried figs, distribution&association with fluorescence’ J. Agric.& Food Chem, 36 (1) 88-91, (1988)
M. Y. Waked, ‘The relationship of infection depth to aflatoxin content in cottonseeds infected with Apergillus flavus’, Mededelingen-Rijksuniversiteit-Gent, 49 (3b), 1257-1262, (1984)
A. E. Yousef and E. H. Marth, ‘Use of ultraviolet energy to degrade aflatoxin M1 in raw or heated milk with and without peroxide’, J. Dairy Science, 69 (9), 2243-2247, (1986)

1. A method for the simultaneous decontamination and detoxification of a foodstuff comprising covering the foodstuff with an acidified film of liquid, immediately prior to simultaneously exposing the foodstuff surfaces, in a non-refrigerated but modified atmosphere, to a combination of low pressure and medium pressure lamps emitting UV wavelengths spanning all of the UV-A, UV-B and UV-C radiation bands and optionally providing an additional heat source; the UV lamps and optional additional heat source acting to initiate a rapid rise in temperature at the surface of the foodstuff causing the liquid film to turn to steam, exposing the foodstuff surfaces to a simultaneous decontamination media of steam, Ultraviolet radiation and acid pH, immediately followed by exposure to a combined treatment of a similarly modified but now refrigerated atmosphere, while being continually exposed to the same combination of UV wavelengths, before being subjected to an optional pH treatment upon exiting the treatment chamber to ensure the treated exposed surfaces of the foodstuff are neutral or slightly alkaline.

2. A method according to claim 1 wherein the film of liquid is water.

3. A method according to claim 2 wherein said water has a pH of 4.0 or lower.

4. A method according to claim 2 wherein the water is applied in two or more sequential stages sufficient to remove excess dirt and detritus from the surface of the foodstuff and drain excess moisture, as required.

5. A method according to claim 4 wherein the temperature of the final wash stage water is elevated.

6. A method according to claim 5 wherein the elevated temperature of the final stage water does not induce physical damage or denaturation to the individual foodstuff.

7. A method according to claim 1 wherein the dwell time of the product in the non-refrigerated atmosphere is sufficient to raise the temperature of the foodstuff at a distance of 2 mm under the surface to between 45° C.-50° C.

8. A method according to claim 1 wherein the wavelength of the UV-C output is essentially 254 nm.

9. A method according to claim 1 wherein the total UV-C output is in the range 10 W/cm2-200 W/cm2 and the product receives a total UV-C dosage of 250-2500 J/cm2 per side, applied as a single continuous dose.

10. A method according to claim 1 wherein the total UV-C output is in the range 10 W/cm2-200 W/cm2 and the product receives a total UV-C dosage of 500-1600 J/cm2 per side, applied as a single continuous dose.

11. A method according to claim 1 wherein the UV-A output is between 320 nm and 410 nm and contains wavelengths across the whole UV-A spectrum.

12. A method according to claim 1 wherein the UV-B output is between 280 nm and 320 nm and contains wavelengths across the whole UV-B spectrum.

13. A method according to claim 1 wherein the total UV-A and UV-B output is in the range 2 W/cm2-200 W/cm2 and the product receives a total combined UV-A and UV-B dosage of 200-2500 J/cm2 per side, applied as a single continuous dose.

14. A method according to claim 1 wherein the total UV-A and UV-B output is in the range 2 W/cm2-200 W/cm2 and the product receives a total combined UV-A and UV-B dosage of 300-1000 J/cm2 per side, applied as a single continuous dose.

15. A method according to claim 1 wherein the modified atmosphere in both the refrigerated and non-refrigerated zones is at least 70% V/V Carbon Dioxide.

16. A method according to claim 1 wherein the modified atmosphere in both the refrigerated and non-refrigerated zones is less than 4% Oxygen.

17. A method according to claim 1 wherein the temperature of the refrigerated modified atmosphere is less than 10° C.

18. A method according to claim 1 wherein the temperature of the refrigerated modified atmosphere is less than 5° C.

19. A method according to claim 1 wherein the relative humidity of the modified and refrigerated atmosphere is maintained at or above the dew point temperature of each foodstuff so as to prevent the reformation of moisture on the product surface after treatment.

20. A method according to claim 1 wherein the foodstuff is disposed in a monolayer for treatment.

21. A method according to claim 1 wherein the refrigerated and modified atmosphere is fed into the system from below the height of the foodstuff.

22. A method according to claim 21 wherein the refrigerated and modified atmosphere is fed into the system from the underside of the product conveying surfaces.

23. A method according to claim 1 wherein the foodstuff is rotated as necessary so that all exposed surfaces receive essentially the same treatment.

24. A method according to claim 1 wherein the pH of the product surface after treatment is adjusted to be neutral or slightly alkaline pH so as to be between pH 7.0 and 9.0.

25. A method according to any of claim 1 wherein no step of the treatment would cause the foodstuffs to be physically damaged or denatured.

26. A method according to claim 1 wherein a suitable foodstuff is defined as any foodstuff that is known to become contaminated with organisms of microbial origin and/or toxins and/or organisms capable of generating toxins.

27. A method according to claim 1 wherein the suitable foodstuff is preferably a nut or grain or vegetable or fruit.
